(19) United States
(12) Patent Application Publication
(10) Pub. No.: US 2023/0316218 A1
(43) Pub. Date: Oct. 5, 2023

(54) PICK-UP STATION

(71) Applicant: Pavilion Capital, LLC, Charlotte, NC (US)

(72) Inventors: Richard M. Davies, Charlotte, NC (US); Jim Gamble, Charlotte, NC (US); Marnie Harris, Charlotte, NC (US); Abby Trammel, Charlotte, NC (US)

(73) Assignee: Pavilion Capital, LLC, Charlotte, NC (US)

(21) Appl. No.: 18/130,758

(22) Filed: Apr. 4, 2023

Related U.S. Application Data
(60) Provisional application No. 63/327,509, filed on Apr. 5, 2022.

(51) Int. Cl. G06Q 10/0836; G06Q 10/0832; G07C 9/22; G07C 9/00

(52) U.S. Cl. CPC G06Q 10/0836; G06Q 10/0832; G07C 9/22; G07C 9/00896

(57) ABSTRACT

An object pick-up station for retrieving objects is provided. The object pick-up station includes a locker and one or more locker adjustment assemblies. The locker includes an object compartment configured to store one or more objects for retrieval by a recipient. The object compartment may be climate controlled. The locker also includes a user interface configured to verify a depositor and/or a recipient. The locker further includes a locker barrier configured to allow access to the object compartment upon verification of the depositor and/or recipient. The one or more locker adjustment assemblies are configured to adjust the position of the locker based on vehicle information of a vehicle utilizing the object pick-up station.

### CROSS REFERENCE AND PRIORITY CLAIM UNDER 35 U.S.C. § 119

The present application for a patent claims priority to U.S. Provisional Patent Application Ser. No. 63/327,509 entitled “Pick-up Station,” filed on Apr. 5, 2022, and assigned to the assignees hereof and hereby expressly incorporated by reference herein.

### FIELD

The present invention relates to an object retrieval station, and more particularly to, a system, method, computer program product, and mechanisms for a pick-up station that facilitates retrieval of objects.

### BACKGROUND

Conventional lockers do not have the capability to facilitate the easy of delivery and receipt of objects for different types of vehicles. As such, there exists a need for a system, a method, a computer program product, and mechanisms to facilitate order delivery and receipt.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the invention relate to an object pick-up station for retrieving objects. The object pick-up station includes a locker and one or more locker adjustment assemblies. The locker includes an object retrieval compartment configured to store one or more objects for retrieval by a recipient. The object retrieval compartment may be climate controlled. The locker also includes a user interface configured to verify the depositor and/or recipient. The locker further includes a locker barrier configured to allow access to the object compartment upon verification of the depositor and/or recipient. The one or more locker adjustment assemblies are configured to adjust the position of the locker based on a vehicle information of a vehicle utilizing the object pick-up station.

One embodiment of the disclosure is an object pick-up station for retrieving objects. The object pick-up station comprises a locker comprising an object compartment configured to store one or more objects for retrieval by a recipient, an interface configured to authenticate the recipient, and a locker barrier configured to allow access to the object compartment upon authentication of the recipient. The object pick-up station further comprises one or more adjustment assemblies configured to adjust a position of the locker based on a recipient vehicle.

In further accord with embodiments, the object pick-up station further comprises one or more sensors configured to determine vehicle information of the recipient vehicle.

In other embodiments, the object pick-up station further comprises an object tray configured to extend from the object compartment in a direction of the recipient vehicle adjacent to the object pick-up station. The one or more objects are extended toward the recipient vehicle by the object tray.

In yet other embodiments, the object tray comprises a retractable tray wall configured to raise and lower.

In still other embodiments, the interface is at least one of a scanner, a keypad, a touchscreen display, or a wireless communication device.

In further accord with embodiments, the one or more adjustment assemblies comprise an adjustment member and an adjustment drive.

In other embodiments, the adjustment member comprises a telescoping leg, a rotational screw, a pivoting arm, or a carriage and track.

In yet other embodiments, the adjustment drive comprises an electric motor, a hydraulic drive, a pneumatic drive, or an inflatable vessel.

In still other embodiments, the one or more adjustment assemblies adjust the position of the locker vertically.

In further accord with embodiments, the one or more adjustment assemblies adjust the position of the locker rotationally.

In other embodiments, the one or more adjustment assemblies adjust the position of the locker horizontally.

In yet other embodiments, the locker comprises two or more object compartments configured to store the one or more objects.

In still other embodiments, the locker further comprises a compartment drive configured to move the two or more object compartments within the locker.

In further accord with embodiments, the locker is temperature controlled.

In other embodiments, the object pick-up station further comprises two or more lockers configured to store two or more orders.

In yet other embodiments, the object pick-up station further comprises a trash disposal device configured to receive an object of the one or more objects from the object compartment.

Another embodiment of the disclosure comprises a system for facilitating an object retrieval. The system comprises, one or more network communication interfaces, one or more memories having computer readable code stored therein, and one or more processing devices operatively coupled to the one or more memories and the one or more network communication interfaces. When executed the computer readable code causes the one or more processing devices to receive vehicle information of a vehicle and activate one or more adjustment assemblies to adjust a locker position based on the vehicle information of the vehicle. The one or more processing devices receive an object deposit request or an object retrieval request, wherein the object deposit request or the object retrieval request comprises authentication information for a user. The one or more processing devices are further configured to unlock a locker barrier to allow access to an object compartment for one or more objects based on the authentication information.

In further accord with embodiments, when executed the computer readable code further causes the one or more processing devices to activate an object tray configured to extend from the object compartment in a direction of the vehicle adjacent to the object pick-up station. The one or more objects are extended toward the vehicle by the object tray.

Another embodiment of the disclosure comprises a method for facilitating an object retrieval from an object pick-up station. The object pick-up station comprises a locker comprising an object compartment, an interface configured to authenticate a depositor or a recipient, and a locker compartment barrier. The object pick-up station further comprises one or more adjustment assemblies configured to adjust a position of the locker. The method comprises receiving vehicle information of a vehicle and activating the one or more adjustment assemblies to adjust the position of the locker based on the vehicle information of the vehicle. The method further comprises receiving an object deposit request or an object retrieval request, wherein the object deposit request or the object retrieval request comprises authentication information for the depositor or the recipient. The method comprises unlocking the locker barrier based on the authentication information to allow access to the object compartment for depositing or retrieval of one or more objects.

In further accord with embodiments of the disclosure, the method further comprises activating an object tray configured to extend from the object compartment in a direction of the vehicle adjacent to the object pick-up station.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A provides an example drive-thru object pick-up station 100 in accordance with example embodiments of the present disclosure;

FIG. 1B provides another example drive-thru object pick-up station 100 in accordance with example embodiments of the present disclosure;

FIG. 1C provides another example drive-thru object pick-up station 100 in accordance with example embodiments of the present disclosure;

FIG. 2 provides an example object pick-up location 200 with multiple object pick-up stations 100A-100C in accordance with example embodiments of the present disclosure;

FIG. 3 provides a block diagram illustrating a system environment 300 for facilitating retrieval of objects using an object pick-up station 100, in accordance with example embodiments of the present disclosure

FIG. 4 provides a block diagram illustrating the pick-up fulfillment system 400 in greater detail, in accordance with example embodiments of the disclosure;

FIG. 5 provides a block diagram illustrating embodiments of the object pick-up station 100 for receiving, storing, and delivering objects, in accordance with embodiments of the disclosure; and

FIG. 6 provides a process flow for delivery and retrieval of objects using a pick-up station 100, in accordance with embodiments of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the term “vendors” may include any business organization that provides goods and/or services to one or more customers. Examples of vendors may include, but are not limited to, restaurants, fast food, fast casual, ghost kitchens, pharmacies, e-commerce institutions, clothing stores, hardware stores, home improvement stores, grocery stores, retail warehouses, convenience stores, cosmetic stores, electronic stores, lens/glasses stores, liquor stores, any type of retail store, and/or the like.

Furthermore, embodiments of the present invention use the term “user,” “end user,” or “customer user.” In accordance with embodiments of the invention, a user may be a customer that utilizes the present invention to place one or more multi-vendor orders associated with one or more goods provided by one or more vendors located off-site or on site. In accordance with embodiments of the invention, the terms “third party” may include any delivery company that deposits one or more goods to pick-up station for the vendors and/or take receipt of one or more goods from the pick-up station for the users for delivery the users. The term “third party user” may be an employee (e.g., full-time, part-time, contractor, or the like) of the delivery company that picks up one or more goods from the vendor, deposits the one or more goods into the pick-up stations, and/or is the recipient of the one or more goods from the pick-up stations for delivery to end users.

Many of the example embodiments and implementations described herein contemplate interactions engaged in by a user with a computing device and/or one or more communication devices and/or secondary communication devices. Furthermore, as used herein, the term “user computing device” may refer to “mobile device”, such as a mobile phone, tablet computers, wearable devices, smart devices and/or any portable/non-portable electronic device capable of receiving and/or storing data therein. Moreover, a “user computing device” may also refer to desktop computer device, laptop, or other device.

A “user interface” is any device or software that allows a user to input information, such as commands or data, into a device, or that allows the device to output information to the user. For example, the user interface may include a graphical user interface (GUI) or an interface to input computer-executable instructions that direct a processing device to carry out specific functions. The user interface typically employs certain input and output devices to input data received from a user or output data to a user. These input and output devices may include a display, mouse, keyboard, button, touchpad, touch screen, microphone, speaker, LED, light, joystick, switch, buzzer, bell, and/or other user input/output devices for communicating with one or more users. A user interface may also include a scanner, such as a QR code scanner, a RFID scanner, camera, optical reader, and/or other type of interface that can capture images, information, or the like.

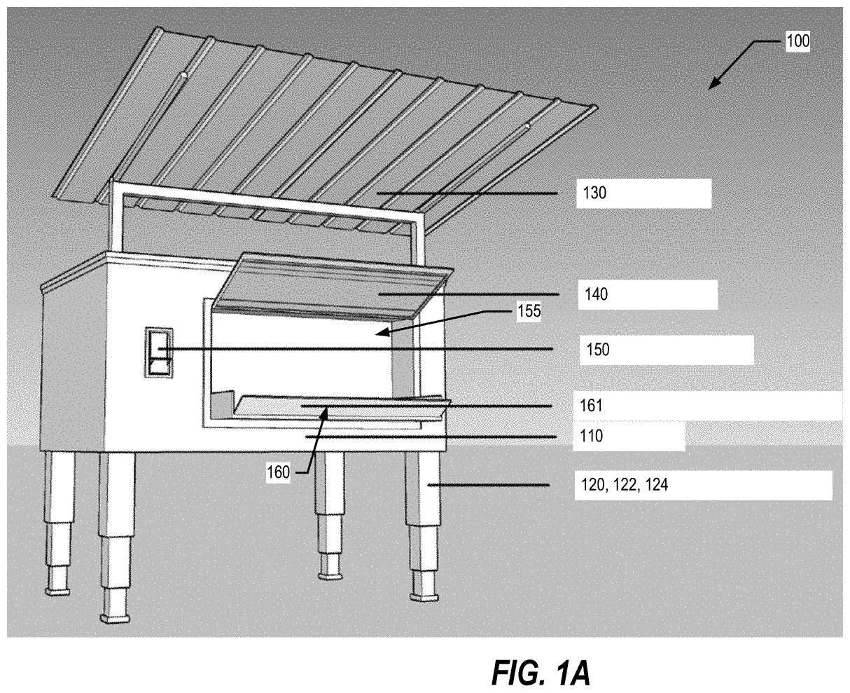

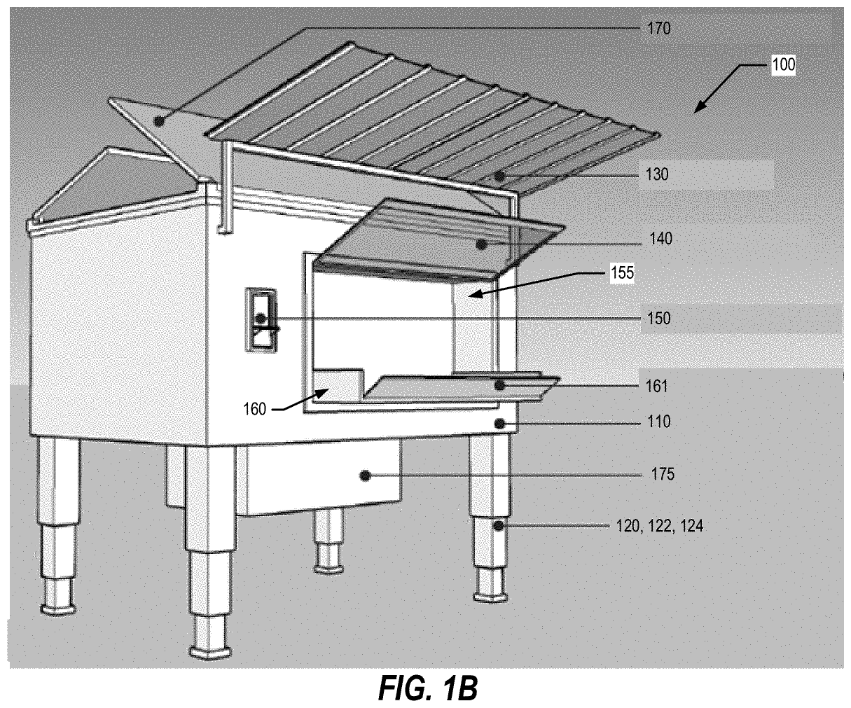

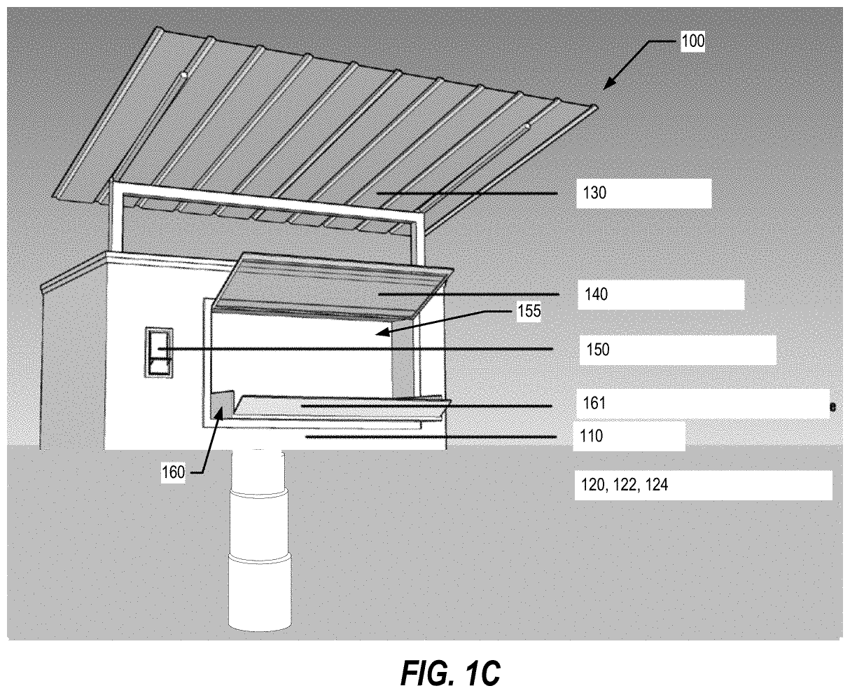

FIG. 1A provides an example object pick-up station 100 in accordance with various embodiments of the present disclosure. The object pick-up station 100 may include at least one locker 110, one or more locker adjustment assemblies 120 (e.g., adjustment members 122, illustrated in the figures as four locker legs or a single leg), and/or a locker cover 130. The object pick-up station 100 is configured to be positioned in a location for a recipient (e.g., user or autonomous vehicle) to receive an object (or a plurality of objects), such as an order that has one or more objects. The object pick-up station 100 may be positioned such that a user can retrieve the object while located within a vehicle (e.g., without exiting the vehicle). For example, the object pick-up station 100 may be positioned in or adjacent to an area that allows for ingress and egress of vehicles, such as a parking lot, roadway, drive-through, or other form of vehicle passage, such that a vehicle can pull alongside the object pick-up station 100 to retrieve the objects from the object pick-up station 100 while remaining in the vehicle. It should be understood that the pick-up station 100 may be located on-site at a location of one or more vendors, or off-site from one or more vendors to allow for multiple vendors to utilize the pick-up station 100, as will be described in further detail herein.

One or more objects, such as from an order placed by a customer user, may be retrieved from object pick-up stations 100. The one or more objects can include food (e.g., centralized food delivery services), packages (e.g., centralized delivery locations), medicine, and/or other products that may be stored and retrieved by a user. Various object pick-up stations 100 may be specially designed based on the type of object to be stored in the object pick-up station 100. Additionally, or alternatively, the object pick-up stations 100 may be multi-purpose such that the operation of the object pick-up station 100 may change based on the type of object being stored.

The object pick-up station 100 may have one or more lockers 110. The locker 110 of the object pick-up station 100 comprises one or more object compartments 155 (e.g., object deposit compartments, object retrieval compartments, or the like), such as an interior storage area, in which one or more objects can be deposited to be retrieved by the intended recipient (e.g., a user, such as a third-party retrieval user, customer user, or other like user, or an autonomous recipient, such as an automated ground vehicle, air vehicle, or the like for retrieving the one or more objects). It should be understood that the object retrieval compartments 155 may be any shape and/or size, and may have a single compartment section or multiple compartment sections.

The locker 110 may have a locker compartment barrier 140 (e.g., door, window, or the like) that opens (e.g., swings, slides, folds, or the like) to allow an object to be retrieved from the object retrieval compartment 155. The locker compartment barrier 140 may be automated (e.g., opens upon authentication of the user, such as receiving a code entered, provided, displayed, or the like to the user interface 150 of the locker 110 manually from a user, wireless from a user, automatically based on sensors, or the like).

The object pick-up station 100 may have one or more sensors to perform various functions, such as movement (e.g., height adjustment, rotational adjustment, horizontal adjustment, or the like), locker compartment barrier 140 opening and closing, tray extension and/or retraction, or the like. The one or more sensors may include cameras, radar, ultrasonic, LiDAR, near field communication, wireless communication, light curtains, other lasers, infrared, or the like sensors. With respect to the locker compartment barrier 140, one or more sensors may be used to allow for opening of the locker compartment barrier 140 without hitting the intended recipient or recipient vehicle. The locker compartment barrier 140 may open to reveal one or more object retrieval compartments 155. The one or more object retrieval compartments 155 may be the area in which the object(s) to be retrieved is located. In some instances, the object may be located in the object retrieval compartment 155 upon being placed into the object pick-up station 100 (e.g., the locker 110 may have a one or more individual object retrieval compartments 155 that are capable of containing objects to be retrieved). In some instances, the objects may be located in a different portion of the locker 110 and are moved from the different portion of the locker 110 to the object retrieval compartment 155 for retrieval by the intended recipient when the recipient user access the locker 110. The object compartments 155 may move to different positions within the locker 110 through one or more compartment members (e.g., through the use of a track, gears, belts, pullies, carriages, conveyor, rollers, arms or the like) and/or compartment drives (e.g., motors, solenoids, pistons, or the like). For example, in some embodiments, the compartments may be rotated into place for depositing and/or retrieval based on the rotation of the compartments 155 (e.g., rotating table, track, conveyor, or the like that moves the compartments).

The object retrieval compartment 155 may be sized to allow for a plurality of objects to be placed within the object retrieval compartment 155. For example, multiple objects with the same intended recipient may be placed in the same object retrieval compartment 155, such that the intended recipient can retrieve multiple objects from the object pick-up station 100 at the same time. In an example embodiment, the object retrieval compartment 155 is capable of containing at least two objects of a certain size at a given time. In another example embodiment, multiple object retrieval compartments 155 are capable of containing at least two objects of a certain size at a given time for retrieval by one or more recipient users. As such, it should be understood that multiple vendors may place one or more objects into one or more compartments 155 (e.g., a single compartment 155, or different compartments 155) for retrieval by one or more intended recipients (e.g., a single recipient user, different recipient users, single autonomous vehicle, multiple autonomous vehicles, or the like).

The object pick-up stations 100 and/or the one or more object retrieval compartments 155 thereof may be sized based on objects expected to typically be stored by the object pick-up station 100 and/or the one or more object retrieval compartments 155. For example, multiple object pick-up stations 100 may be placed at a given location with each of the object pick-up stations 100 being capable of storing different size objects (e.g., a first object pick-up station 100 may be sized to typically store small objects and a second object pick-up station may be sized to typically store larger objects). In other embodiments, each object pick-up station 100 may have one or more object retrieval compartments 155 of different sizes capable of storing different size objects (e.g., a first object retrieval compartment 155 may be sized to store small objects and a second object retrieval compartment 155 may be sized to store larger objects).

At least a portion of the locker 110 may be climate controlled (e.g., temperature, humidity, air flow, or the like). In some instances, the entire interior storage area may be climate controlled. In some instances, one or more individual object retrieval compartments 155 may be climate controlled (e.g., a first object retrieval compartment 155 may be kept at a different temperature than a second object retrieval compartment 155). In some instances, the object pick-up station 100 may be a cooled object pick-up station, a heated object pick-up station, and/or have cooled and/or heated object retrieval compartments 155, such that the temperature is maintained to protect the objects stored within. For example, in an instance in which the objects within the object pick-up station 100 are frozen (e.g., frozen food, drinks or foods that are served cold, medicine that must be maintained at a cold temperature, or the like), then at least a portion of the locker 110 may be cooled to a temperature less than the ambient temperature (e.g., a cold refrigerator, a freezer, or the like). Alternatively, in an instance the object should be maintained at a high temperature (e.g., prepared food, or the like), then a portion of the locker 110 may be heated to a temperature greater than ambient temperature (e.g., to keep the object warm). In some instances, the locker 110 may be maintained at a set temperature (e.g., room temperature). For example, the locker 110 may be temperature controlled to avoid issues related to changes in ambient temperature (e.g., to keep a product from freezing in the winter, to keep an object cool during the summer, or the like). Moreover, the humidity of the locker and/or compartments thereof may be controlled based on the objects located in the compartments. Furthermore, air flow may be maintained in order to prevent the object from sitting in stagnant air. As such, an air flow device (e.g., fan, blower, air filters, vents, or the like) may be used to allow for movement of air through the locker, such as through the one or more compartments 155.

The climate of the locker 110 may be controlled remotely (e.g., such as via a network). The locker 110 may include one or more climate sensors (e.g., temperature sensors, humidity sensors, air flow sensors, or the like) to monitor the climate, such as one or more interior compartment sensors and one or more exterior locker sensors to monitor the interior and exterior climate. The locker 110 may also include various heating and/or cooling components, humidifier and/or dehumidifiers, fans, blowers, or the like in order to achieve the intended climate (e.g., temperature, humidity, air flow, or the like) within the locker 110. In some instances, the intended climate of the locker 110 may be provided by the object sender (e.g., a restaurant may provide recommended temperature for prepared food to maintain while waiting to be picked up, a pharmacy may provide a recommended temperature and humidity for medicine, or the like). Additionally, or alternatively, the object pick-up stations 100 may have default climate settings (e.g., in instances in which no recommendations are known).

It should be further understood that the lockers 110 and/or compartments 155 thereof may be self-cleaning and/or disinfecting, such as through the use of UV light, automated cleaning dispensers (e.g., misters, or the like), drying components (e.g., fans, blowers, heat lamps, or the like). As discussed in reference to FIG. 1B, an object pick-up station 100 may include a trash disposal device(s) 175 (e.g., container, compactor, or the like), as will be described in further detail herein, that is configured to dispose of objects within the object pick-up station 100.

As shown, the locker 110 may also include an object tray 160 (e.g., object retrieval tray, object deposit tray, or the like) configured to extend the object compartment 155 and/or extend from the object compartment 155. In some embodiments, the object retrieval tray 160 may extend in the direction of the intended recipient (e.g., the object retrieval tray 160 may extend in the direction of the vehicle adjacent to the object pick-up station 100). The object(s) to be retrieved may be located within the object retrieval compartment 155 and/or located on the object retrieval tray 160, such that the object to be retrieved is also extended in the direction of the intended recipient user. The object pick-up station 100 may have one or more sensors to allow the object retrieval tray 160 to extend without hitting the intended recipient user or vehicle of the intended recipient user. For example, the sensors may identify (e.g., before or during opening) the distance the object tray 160 (e.g., edge, retractable tray face described below, or the like of the tray) is located from a vehicle, and in response the controller determines how far to extend the object tray 160.

The object tray 160 may include a retractable tray face that is configured to raise and lower to allow easier access to the object located within the object compartment 155 and/or located on the object tray 160. The object tray 160 may include one or tray walls that are configured to aid in restricting the object(s) from falling off the object tray 160. In an instance in which the object tray 160 has a tray wall located on the extended edge of the object tray (e.g., retractable tray wall 161 located between the object(s) and the intended recipient), the tray wall may raise and lower to allow the intended recipient to easily retrieve the object. The retractable tray wall 161 may be automated (e.g., the retractable tray wall 161 may lower to allow easier access to the object on the object tray 160 in an instance in which the object tray 160 has extended in the direction of the intended recipient) and/or manual (e.g., the intended recipient may be able to easily raise and lower the retractable tray wall 161). The object tray 160 and/or tray wall 161 may be moveable through the use of one or more tray members (e.g., tracks, gears, belts, pullies, carriages, conveyor, rollers, arms, or the like) and/or one or more tray drives (e.g., motors, solenoids, pistons, or the like).

The locker 110 may have one or more access barriers (e.g., doors, windows, slides, or the like) configured to allow object(s) to be deposited in the one or more compartments 155. The access barrier may be on the side (e.g., rear) of the locker 110 opposite of the locker compartment barrier 140. However, it should be understood that the access barrier may be located on the top, sides, or underneath the locker 110. In some embodiments, objects can be placed into the locker 110 without interrupting retrieval of other objects in the locker 110. For example, the locker 110 may have one or more storage areas that may be store an object before being moved (e.g., placed, or the like) to the object retrieval compartment 155. Alternatively, or additionally, the multiple object retrieval compartments 155 may be accessed individually through the access barriers. For example, depositors may only be able to access certain compartments 155 to deposit one or more objects, while recipients may be able to access multiple compartments 155 to access the objects of a single order from multiple compartments. The access barrier may be accessed manually (e.g., a delivery user using a code, key, wireless communication, or the like) for depositing the object into the locker 110 via the access barrier. Additionally, or alternatively, the access barrier may be accessed by one or more autonomous devices (e.g., an autonomous vehicle and/or robotic device can deliver the object from the object origin to the object pick-up station). It should be understood that the one or more access barriers may include one or more object deposit trays that extend to aid the user in depositing the one or more objects within the pick-up station. The one or more object deposit trays may be the same as or similar to the one or more object trays 160 described herein (e.g., object retrieval trays). While the access barrier for the locker 110 of the pick-up stations 100 may be separate from the locker compartment barrier 140, it should be understood that the one or more objects may be delivered through the same locker compartment barrier 140 that is used to retrieve the one or more objects.

Moreover, as will be described in further detail below, the pick-up station 100 may have one or more adjustment assemblies 120 having one or more adjustment members 122 and/or one or more adjustment drives 124. The one or more adjustment assemblies 120 may adjust the pick-up stations 100 to aid in allowing a depositor, such as a user (e.g., a delivery user, from the object provider or a third-party in a vehicle) or an autonomous delivery vehicle (e.g., automated ground, air, or the like vehicle) to deposit the objects in the pick-up station 100. As will be described in further detail herein, the one or more adjustment assemblies 120 may be adjusted (e.g., vertically, horizontally, rotationally, or the like) based on the depositor vehicle being used to deliver the objects to the pick-up station 100.

The locker 110 may include one or more interfaces (e.g., a retrieval interface 150, depositor interface, or the like) with which a user or autonomous vehicle can engage in order to activate the depositing and/or retrieval of the one or more objects from the object pick-up station 100. The interface 150 may be any device or software that allows a user to input information (e.g., manually or automatically) and/or an autonomous vehicle to provide information, such as commands or data, into a device, or that allows the device to output information to the user and/or autonomous vehicle. For example, the interface 150 may include a graphical user interface (GUI) or an interface to input computer-executable instructions that direct a processing device to carry out specific functions (e.g., for depositing and/or retrieving the one or more objects). The interface may include a display, mouse, keyboard, button, touchpad, touch screen, microphone, speaker, LED, light, joystick, switch, buzzer, bell, camera, communication interface (e.g., wireless, or the like communication device) and/or other user input/output devices for communicating with one or more users and/or user computer systems of the one or more users. The interface 150 may include a scanner (otherwise described as reader), such as a QR code scanner, barcode scanner, a RFID scanner, and/or any other type of scanner.

The interface 150 (e.g., a retrieval interface 150, depositor interface, or the like) may be positioned such that a user can easily access the interface 150 from the vehicle adjacent to the object pick-up station 100. For example, the interface 150 may be approximately the same height as the locker compartment barrier 140, such that the interface 150 is within an arms-length of a user in the adjacent vehicle in an instance the one or more locker adjustment assemblies 120 have been moved to the intended locker leg height, discussed herein. Alternatively, or additionally, the interface 150 may be adjustable (e.g., attached to a manually adjusted support, an automated adjustable support, or the like) with respect to the object pick-up station 100). As such, in addition to the adjustment of the pick-up station 100 (as will be described in further detail below) and/or the adjustment of the object retrieval tray 160, the interface 150 may be extended from the pick-up station 100 to a location adjacent a user and/or window of a user's vehicle. For example, the interface 150 may be extended through the use of an interface member (e.g., telescoping arm, a retractable arm, swinging arm, or other like member) using an interface drive (e.g., a motor, solenoid, piston, or the like). In some embodiments, one or more sensors may be used in order to aid in extending the interface 150 towards the vehicle in order to allow a user to provide authentication for accessing the objects within the pick-up station 100.

As previously described herein, the object pick-up station 100 may include one or more locker adjustment assemblies 120 attached to the locker 110 in order to raise or lower the locker 110 to an intended level to allow access by a depositor or recipient of the one or more objects. FIG. 1A illustrates an object pick-up station 100 having four locker adjustment assemblies 120 (e.g., four legs, or the like). Alternatively FIG. 1B illustrates an object pick-up station 100 having a single locker adjustment assembly 120 (e.g., a single leg, or the like). However, it should be understood that any number of locker adjustment assemblies 120 may be used (e.g., one, two, three, four, five, or the like). The one or more locker adjustment assemblies 120 may be moveable, such as vertically to provide an adjustable height, such that the height of the locker 110 of object pick-up station 100 can be adjusted. In some embodiments, the one or more locker adjustment assemblies 120 may be moveable rotationally, such as to turn the locker 110 from one orientation to another orientation. For example, the locker 110 may be moveable from a recipient orientation in which a recipient receives the one or more objects (e.g., in a receiving lane of recipient vehicles, or the like) to a depositor orientation (e.g., in a depositor lane of depositing vehicles, or the like). In other embodiments, the one or more locker adjustment assemblies 120 may be moveable horizontally, in order to adjust the horizontal location at which one or more vehicles may be able to receive the objects. The object pick-up station 100 may include one or more sensors configured to determine the height of the vehicle receiving the object (e.g., located adjacent to the object pick-up station 100, entering the pick-up station premises, or the like). The object pick-up station 100 determines the height of the vehicle in order to raise/lower the locker 110 such that the object can be easily retrieved by the recipient (e.g., a user in the vehicle, an autonomous vehicle, or the like). For example, the locker 110 is raised or lowered in order for the object retrieval tray 160 to be approximately the same height of the driver window (e.g., fully opened window, partially opened window, or the like) of the vehicle adjacent to the object pick-up station 100. The locker 110 height may be adjusted for each vehicle that approaches the object pick-up station 100. While it should be understood that the one or more locker adjustment assemblies 120 are located below the locker 110, it should be understood that the locker(s) 110 of the object pick-up stations 100 may be raised and lowered from an above structure (e.g., hanging from a support structure, or the like).

The one or more locker adjustment assemblies 120 may comprise one or more adjustment members 122 (e.g., adjustment legs, or the like) that may have a telescoping construction that allows the length of the adjustment members (e.g., legs, or the like) to increase and/or decrease. Alternatively, or additionally, the one or more locker adjustment members 122 may have one or more members that pivot with respect to each other (e.g., multiple arms that extend and retract) in order to adjust the height of the locker 100. Alternatively, or additionally, the one or more locker adjustment members 122 may be adjustable through the use of one or more carriages and/or tracks that allow the carriages to slide with respect to the tracks. Alternatively, or additionally, in still other embodiments, the one or more locker adjustment members 122 may comprise gears, pulleys, belts, chains, or the like that allows for the adjustment of the locker 110. Alternatively, or additionally, the one or more locker adjustment members 122 may comprise rotational members (e.g., augers, screws, or the like) that rotate in order to raise or lower the locker 110. In still other embodiments, the one or more locker adjustment members 122 may be adjustable through the use of inflatable and/or deflectable vessels (e.g., flexible bags, bellows, bladders, or the like).

It should be further understood that the one or more locker adjustment assemblies 120 may comprise of one or more adjustment member drives 126 that are used to engage and/or disengage (e.g., move, rotate, inflate, or the like) the one or more locker adjustment members 122. For example, the one or more adjustment member drives 124 may comprise a motor, solenoid, pistons, pumps, blowers, or the like. As such, regardless of the specific type of one or more locker adjustment members 122, the locker adjustment members 122 may be actuated in a number of different ways. For example, the locker adjustment members 120 may be adjusted hydraulically through the use of hydraulic actuators (e.g., pistons, hydraulic fluid, tubes, valves, or the like). Alternatively, or additionally, in some embodiments the locker adjustment members 120 may be pneumatically actuated through the use of pneumatic actuators (e.g., pistons, air or other gases, tubes, valves, or the like). Alternatively, or additionally, the locker adjustment members 120 may be adjusted electrically through the use of electric motors (e.g., DC, AC, brushless, brushed, direct drive, linear, servo, stepper, hysteresis, reluctance, universal, or any other type of motor). In other embodiments, pumps may be used to inflate and/or deflate a vessel.

Regardless of how the one or more locker adjustment members 122 are actuated to adjust the height of the locker 110, the intended locker height may be determined through the use of a controller and one or more sensors, which identifies vehicle information (e.g., type of vehicle, the vehicle height, location of vehicle window, position of an open window of the vehicle, or the like) of a vehicle of a recipient being used to pick up an order. In some embodiments, the vehicle information may be based on the type of vehicle inputted when the order is placed. In other embodiments, the type of vehicle may be determined when the vehicle arrives on site and/or is located adjacent to the pick-up station 100. For example, a location determining device (e.g., GPS) or the like may be used to identify when the vehicle arrives on-site. Alternatively, or additionally, one or more sensors on the pick-up station 100 and/or one or more sensors located on the site (e.g., in the entry of the site, lane of the pick-up station) determines the vehicle information. The vehicle information may be used to determine a pick-up station 100 height, and upon determination of the intended pick-up station height, the object pick-up station 100 is configured to automatically actuate the movement of the one or more locker adjustment members 122 (e.g., legs, or the like) using the one or more adjustment drives 124 until the one or more locker adjustment members 122 move the locker 110 to the intended locker location (e.g., height) in view of the vehicle information when the vehicle approaches and/or arrives at the pick-up station 100. While the one or more adjustment assemblies 120 are described as being used for a recipient picking up one or more objects, the one or more adjustment assemblies 120 may be used for a depositor delivering the one or more objects to the pick-up station 100.

It should be understood that while the one or more adjustment assemblies 120 are able to position the locker 110 (e.g., vertically, horizontally, rotationally, or the like) as described herein, it should be understood that in some embodiments, the entire pick-up station 100 may be mobile. For example, the one or more adjustment assemblies 120, or separate one or more mobile assemblies (not illustrated) that are operatively coupled to the pick-up station 100, may be utilized to move the entire pick-up station 100. For example, the one or more mobile assemblies may comprise of one or more mobile members and one or more mobile drives. The one or more mobile members may comprise wheels, tracks, rails, carriages, arms, gears, pulleys, belts, chains, axels, screws, or other like mobile members that allow the pick-up station 100 to move horizontally (e.g., along the ground, or the like) in one or more directions.

The one or more mobile members may be moved through the use of one or more mobile member drives (not illustrated) that are used to engage and/or disengage (e.g., move, position, or the like) the one or more mobile members. For example, the one or more mobile member drives may comprise a motor, solenoid, pistons, pumps, or the like. As such, regardless of the specific type of one or more mobile members, the mobile members may be actuated in a number of different ways. For example, the mobile members may be moved hydraulically through the use of hydraulic actuators (e.g., pistons, hydraulic fluid, tubes, valves, or the like). Alternatively, or additionally, in some embodiments the mobile members may be pneumatically actuated through the use of pneumatic actuators (e.g., pistons, air or other gases, tubes, valves, or the like). Alternatively, or additionally, the mobile members may be engaged and/or disengaged electrically through the use of electric motors (e.g., DC, AC, brushless, brushed, direct drive, linear, servo, stepper, hysteresis, reluctance, universal, or any other type of motor).

The one or more mobile assemblies may allow the pick-up station(s) 100 to move along the ground or may be located on the side or above the pick-up station(s) 100 (e.g., hung from a support structure) in order to allow the pick-up station(s) 100 to move around the pick-up location 200. As such, regardless of the specific components of the one or more mobile assemblies, the pick-up station 100 itself may be a mobile pick-up station that is able to move within the object pick-up location 200 (described in further detail below) to facilitate the depositing and/or retrieval of objects within the locker 100. For example, the pick-up station 100 may move within the pick-up location 200 to aid in providing efficient traffic flow through the pick-up location 200 and/or to the locate the pick-up stations 100 for depositing of the objects by depositors before moving to areas to allow for retrieval of objects by the recipients.

In some embodiments, the mobile pick-up stations 100 may be able to move off-site to other locations (e.g., vendor locations, customer locations, or the like) as a mobile autonomous pick-up station in order to improve the efficiency of depositing of objects from vendors and/or retrieval of the objects by recipients.

As such, the one or more adjustment assemblies 120 and/or the one or more mobile assemblies (not illustrated) allow the pick-up stations 100 to be adjusted (e.g., vertically, horizontally, rotationally, or the like) and/or moveable on-site and/or off-site from the pick-up station location 200 in order to efficiently allow the objects for orders to be deposited and/or retrieved from the pick-up stations 100.

The object pick-up station 100 may also include a locker cover 130. The locker cover 130 may be provided to cover at least a portion of the object pick-up station 100 and/or the area adjacent to the object pick-up station 100 (e.g., the area in which a vehicle is located to retrieve an object from the object pick-up station 100). The locker cover 130 may at least partially cover the object retrieval tray 160 when it is in the extended position and/or at least a portion of the vehicle that is retrieving the object. In other embodiments, the locker cover 130 may at least partially cover the access barrier, the extendable deposit tray, and/or a depositor vehicle being used to deposit the one or more objects into the pick-up station 100. In some instances, the locker cover 130 may be attached to the locker 110 (as shown in FIGS. 1A through 1C). Alternatively, the locker cover 130 may be a separate structure with independent supports. The locker cover 130 may include one or more solar panels attached to the exterior surface in order to power one or more object pick-up stations 100 and/or one or more of the components thereof. For example, the solar panels may be used to power the computer systems of the pick-up station 100, the sensors for the pick-up station 100, the one or more locker adjustment assemblies 120 (e.g., drives, or the like, or the like depending on the type of locker adjustment members), and/or other components of the pick-up station 100 (e.g., batteries thereof).

FIG. 1B is another example object pick-up station 100 in accordance with various embodiments of the present disclosure. Similar to FIGS. 1A and 1B, the object pick-up station 100 may include at least one locker 110, one or more locker adjustment assembles 120 (e.g., illustrated as four locker legs or a single leg), and/or a locker cover 130. The object pick-up station 100 may include each of the components discussed above in reference to FIGS. 1A and 1C. For example, the locker 110 may include a locker compartment barrier 140, an object retrieval tray 160 with a retractable tray wall 161, and an interface 150, and the object pick-up station 100 may include one or more locker adjustment assemblies 120 and a locker cover 130.

As shown in FIG. 1B, the object pick-up station 100 may include an autonomous vehicle hatch, such as a drone delivery hatch 170 configured to open and receive a drone and/or an object carried by a drone for delivery to the pick-up station 100 or allow the drone to receive an object from the pick-up station 100. The drone delivery hatch 170 may be positioned on a horizontal side (e.g., the top side) of the locker 110. For example, as shown, the drone delivery hatch 170 may be a horizontal barrier (e.g., door or doors) that open to receive the drone and/or one or more objects carried by the drone. The barrier of the drone delivery hatch 170 may be opened and/or closed through swinging (e.g., hinged as shown), sliding, folding (e.g., accordion, baffling, or the like), or through other mechanisms. In various embodiments, the drone delivery hatch 170 may be positioned on other sides of the locker 110 (e.g., rear, first side, second side, or the like) and configured to receive a drone delivery. In various embodiments, the drone delivery hatch 170 may be configured to open and close automatically (e.g., via a controller as discussed herein). Moreover, the drone delivery 170 hatch may be used by a drone for retrieval of an object.

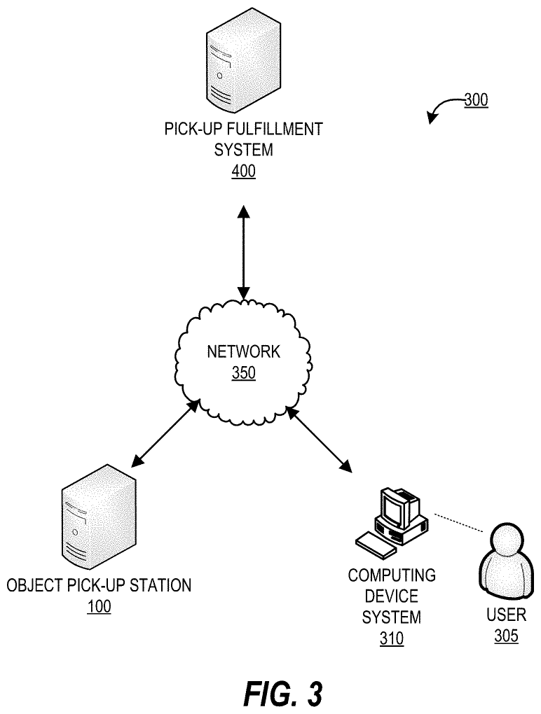

In some embodiments, as will be discussed in further detail herein, the object pick-up station 100 and/or the pick-up fulfillment system 400 discussed in reference to FIGS. 3-5 may be in communication with one or more autonomous vehicles (e.g., ground vehicles, arial vehicles, such as drones, or the like) in order to make a delivery to the object pick-up station 100 (e.g., to an object retrieval compartments 155), such that the drone delivery hatch 170 (or additionally or alternatively the object retrieval tray 160, an object delivery tray, or the like) can be opened for the drone to deliver an object (e.g., food, drink, products, or the like). Additionally, or alternatively, the one or more autonomous vehicles may be able to retrieve an object from the pick-up stations 100 (e.g., object retrieval compartments 155), such as through the autonomous vehicle hatch (e.g., drone delivery hatch 170, or additionally or alternatively through the object retrieval tray 160). Additionally, the object pick-up station 100 may include one or more sensors to detect incoming autonomous vehicles (e.g., drones, or the like) that are making a delivery of an object to, or receiving an object from, the object pick-up station 100 and upon activation of the sensor and authentication of the autonomous vehicle, the object pick-up station 100 is configured to open the drone delivery hatch 170 (or additionally or alternatively the object retrieval tray 160, the object delivery tray, or the like).

As illustrated in FIG. 1B, the object pick-up station 100 may also have one or more trash disposal devices 175, such as a trash compactor, receptable, or the like. The trash disposal 175 shown in FIG. 1B may be configured to dispose of objects (e.g., perishable objects that were not picked up). For example, in an instance in which food is stored within the object pick-up station 100, the food may be moved into the trash disposal 175 after a set amount of time to avoid spoiled food remaining in the object pick-up station 100. In an example embodiment, one or more object retrieval compartments 155 may be connectable to the trash disposal 175, such that an object can be moved from the given compartment into the trash disposal 175 (e.g., though a compartment hatch, slide, drop, or the like).

It should be understood that in some embodiments the trash disposal device(s) 175 may comprise of multiple trash containers (not illustrated) for providing multiple steps for trash disposal (e.g., compacting, or the like). For example, a main disposal 175 (e.g., compactor, or the like) may be utilized to reduce the size of the contents (e.g., food, drink, packaging, or the like) by compressing, shredding, cutting, or the like the contents received from the one or more compartments 155. It should be understood that the main compactor 175 may have a screen, apertures, angled surfaces, or the like for allowing liquids (e.g., from drinks, from the compressed food, or the like) to drain into a liquid compartment (not illustrated) that is separate from the main disposal 175. In some embodiments, once the contents are disposed of (e.g., compacted by the compactor 175, or the like) they may be delivered to a trash receptacle for immediate, or delayed pick-up (e.g., manually or automatically through the use of automated vehicles, devices, systems). In other embodiments, there may be multiple disposals 175 (e.g., compactors, trash receptacles, or the like) such that the different object retrieval compartments 155 may be disposed of into different disposals (e.g., compactors, trash receptacles, or the like). For example, food in one compartment 155 may be disposed of in a compactor for reducing the size of the contents, while a drink in another compartment 155 may be disposed of in another compactor that is specific for liquids. In this way, the locker 100 may be able to more efficiently dispose of perishable items (e.g., food, drinks, plants, flowers, or the like).

Additionally, or alternatively, in the event the object is non-perishable, or a particular delivery includes perishable objects and non-perishable objects, the non-perishable objects may be stored in a container 155 within the pick-up station 100 for retrieval (e.g., by the object provider, a third-party delivery provider, or the like). As such, the object may be stored in one of the compartments 155 within the pick-up station for future retrieval for the vendor that provided the non-perishable object. In some embodiments, the non-perishable object may be automatically supplied to another container located outside of and/or adjacent to the pick-up station for future retrieval for the vendor. As such, if the objects are not retrieved within a particular time period, the pick-up station may be emptied in order to allow for additional orders to be fulfilled.

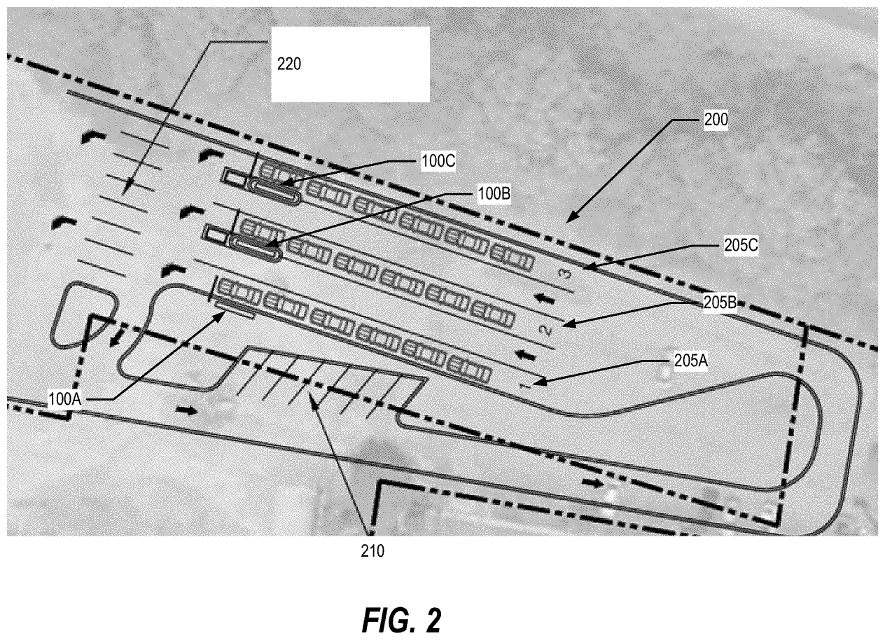

FIG. 2 illustrates an object pick-up location 200 with multiple object pick-up stations 100A-100C in accordance with example embodiments. While FIG. 2 illustrates multiple object pick-up stations 100 at a single object pick-up location, in various embodiments, singular object pick-up stations 100 may be at a given object pick-up location (e.g., a single object pick-up station may be located in a parking lot). Moreover, while single object pick-up stations 100A-100C are located in single lanes, it should be understood that multiple pick-up stations 100 may be located within one or more of the lanes (e.g., in series) in order to allow vehicles entering a lane to proceed to the pick-up station 100 at which their order is located without having to wait in a line of vehicles.

As illustrated in FIG. 2, the object pick-up location 200 may have one or more pick-up lanes 205A-205C that allow vehicles to access (and queue) for an object pick-up station 100. In the example shown in FIG. 2, the object pick-up location 200 has three pick-up lanes 205A-205C, each with an object pick-up station 100A-100C. A user retrieving an object from the object pick-up location 200 may be provided with the specific object pick-up station 100A-100C and/or pick-up lane 205A-205C to enter before or upon arriving at the object pick-up location 200. The pick-up lanes 205A-205C are located adjacent to the given object pick-up station 100A-100C, such that a driver side window of the vehicle is facing the object pick-up station 100A-100C in the instance the vehicle is directly adjacent to the object pick-up station 100A-100C.

The object pick-up location 200 may also include other designated areas in order to help facilitate retrieval. For example, the object pick-up location 200 may have a waiting area 210 in which vehicles can park while waiting for objects to become available. For example, a user may wait in the waiting area 210 until the user receives a notification that the object to be retrieved has been loaded into one of the object pick-up stations 100A-100C. Additionally, the object pick-up location 200 may have one or more object check spots 220 that are positioned to allow for a user to confirm that the intended object was received. The object check spots 220 may also be used for assistance in an instance in which the wrong object is received and/or the object not being in the object pick-up station 100. For example, one or more support users (e.g., support people) may be present to assist customer users with any issues.

In some embodiments, it should be understood that the depositor of the one or more objects may deposit the one or more objects in the pick-up stations 100 using the same pick-up lanes 205A-205C that are being used by the recipients. However, it should be understood that in some embodiments, the site may include one or more depositor lanes located on the back side of the pick-up stations 100 that allow the depositors to deposit the one or more objects on one side of the pick-up station 100, before, during, or after a recipient is utilizing the pick-up station 100 to retrieve one or more other objects.

FIG. 3 provides a block diagram illustrating a system environment 300 for facilitating retrieval of objects using an object pick-up station 100, in accordance with embodiments of the present disclosure. As illustrated in FIG. 3, the environment 300 includes a pick-up fulfillment system 400, one or more object pick-up stations 100, and one or more computing device systems 310 (e.g., user computer systems, third-party user computer systems used by a user 305, or the like). One or more users 305 may be included in the system environment 300, where the users 305 interact with the other systems of the system environment 300 via a user interface of the object pick-up station 100 and/or on the computer device system 310. The one or more users 305 may be the intended recipient of one or more objects within an object pick-up station 100, a vender user depositing the one or more objects, and/or a third-party user facilitating the deposit of the one or more objects for the vendor or retrieval of the one or more objects for the intended recipient user. The system environment 300 may further include one or more autonomous vehicle system(s)s (not illustrated) that are the same as or similar to the computing device system(s) 310.

The pick-up fulfillment system 400 is a system of the present disclosure for performing one or more process steps described herein. The pick-up fulfillment system 400, the object pick-up station 100, and/or the computing device system 310 may be in network communication across the system environment 300 through the network 350. The network 350 may include a local area network (LAN), a wide area network (WAN), and/or a global area network (GAN). In some embodiments, the pick-up fulfillment system 400, the object pick-up station 100, and/or the computing device system 310 may communicate via a network established via Bluetooth communication, RFID, near-field communication (NFC), mesh networking (e.g., Zigbee, or the like), scanners, or any other forms of wireless communications. The network 350 may provide for wireline, wireless, or a combination of wireline and wireless communication between devices in the network. In one embodiment, the network 350 includes the Internet. In general, the pick-up fulfillment system 400 is configured to communicate information or instructions to, or receive information or instructions from, the object pick-up station 100 and/or the computing device system 310 across the network 350. The pick-up fulfilment system 400 may be utilized for orders from one or more vendors, as such, the pick-up fulfillment system 400 may be used for a single vendor or may be used by multiple vendors to provide orders from a single vendor or for consolidating multiple orders for a recipient.

The computing device system 310 may be a system owned or controlled by the user 305 and/or by the entity for which the user 305 is performing a task. As such, the computing device system 310 may be a computing device of the user 305 (e.g., a mobile device as discussed herein, such as a smartphone, wearable device, or the like). In general, the computing device system 310 communicates with the user 305 via a user interface of the computing device system 310, and in turn is configured to communicate information or instructions to, or receive information or instructions from, the pick-up fulfillment system 400 and/or the object pick-up station(s) 100 across the network 350. While the pick-up fulfillment system 400, the object pick-up station(s) 100 and/or the like are illustrated as separate systems, it should be understood that at least one or more of these systems, and the functions thereof, may be combined into a single system, or separated out into other systems. The user 305 may be a customer user 305 that places and/or picks-up an order that is placed by the user 305. The user 305 may be a vendor user 305 that deposits the order into the pick-up station 100. Alternatively, the user 305 may be a third-party user 305 that is contracted for pick-up and delivery, by the vendor or the customer, of the objects for the order. Regardless of the user picking up the object(s), the user 305 may receive information on the status of an object to be picked up via computing device system 310. Additionally, information relating to the steps to retrieve the object(s) from the object pick-up station 100 may also be provided via the computing device system 310. For example, the user 305 may receive a notification that the object is available for pick-up with the location of the object pick-up station 100, as well as the information necessary to access the object(s) (e.g., a code to enter or scan at the object pick-up station 100, wireless communication between the computing device and the pick-up station 100, or the like).

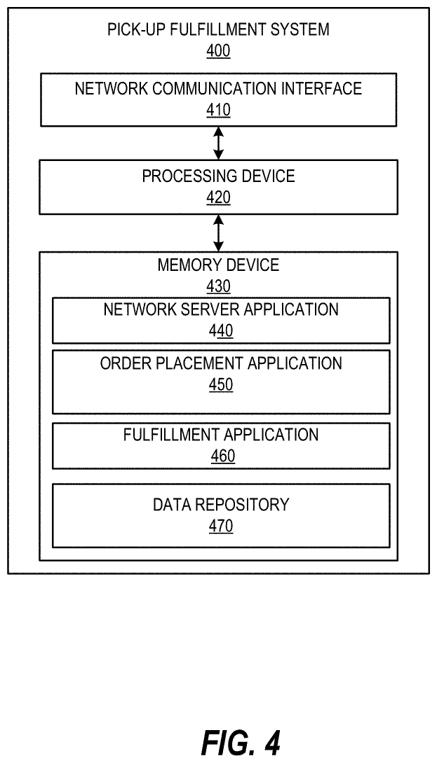

FIG. 4 provides a block diagram illustrating the pick-up fulfillment system 400 in greater detail, in accordance with embodiments of the invention. As illustrated in FIG. 4, in one embodiment of the disclosure, the pick-up fulfillment system 400 includes one or more processing devices 420 operatively coupled to one or more network communication interfaces 410 and one or more memory devices 430.

It should be understood that the one or more memory devices 430 may include one or more databases or other data structures/repositories. The one or more memory devices 430 may also include computer-executable program code, which when executed instructs the one or more processing devices 420 to operate the one or more network communication interfaces 410 to perform certain functions of the pick-up fulfillment system 400 described herein. For example, in one embodiment of the pick-up fulfillment system 400, the memory device 430 includes, but is not limited to, a network provisioning application 440, an order placement application 450, a fulfillment application 460, and a data repository 470 comprising data processed or accessed by one or more applications in the memory device 430. The computer-executable program code of the network provisioning application 440, the order placement application 450, and the fulfillment application 460 may instruct the processing device 420 to perform certain logic, data-processing, and data-storing functions of the pick-up fulfillment system 400 described herein, as well as communication functions of the pick-up fulfillment system 400.

The network provisioning application 440, the order placement application 450, and the fulfillment application 460 are configured to invoke or use the data in the data repository 470 when communicating through the network communication interface 410 with the object pick-up station(s) 100 and/or the computing device system 310. In some embodiments, the network provisioning application 440, the order placement application 450, and the fulfillment application 460 may store the data extracted or received from the object pick-up station(s) 100 and/or the computing device system 310 in the data repository 470.

In some embodiments, the network provisioning application 440, the order placement application 450, and the fulfillment application 460 may be a part of a single application. The order placement application 450 allows the one or more users 105 to place one or more multi-vendor orders via the computing device system 310 via a part of the order placement application that is present in the computing device system 310. The fulfillment application 460 may track the progress of the orders and may assign a pick-up lane and/or object pick-up station 100 for the user to pick-up the object(s) of various orders. Additionally, the fulfillment application 460 may facilitate the verification of the intended recipient for a given object (e.g., the system may determine the object to be retrieved and the location of said object(s) based on an input into the interface 150 of the object pick-up station 100).

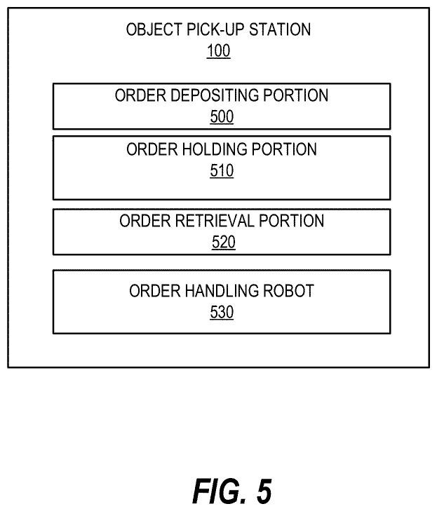

FIG. 5 provides a block diagram illustrating embodiments of the object pick-up station 100 for receiving, storing, and delivering objects, in accordance with embodiments of the disclosure. In some embodiments, the one or more object pick-up stations 100 may comprise one or more of an order depositing portion 500, an order holding portion 510, an order retrieval portion 520, and/or an order robot 530. The order depositing portion 500 may be configured to receive the order from one or more robotic or autonomous delivery systems, including drones. As such, the order depositing portion 500 may be located on the backside of the object pick-up station 100. As described herein, the order depositing portion 500 may include a rear access barrier (e.g., swinging, sliding, retracting, or the like) that may be opened when a depositor (e.g., a user or a robotic delivery system) is adjacent the object pick-up station 100 (e.g., approaches the pick-up station, is located next to the pick-up station, or the like). In some embodiments, the order depositing portion 500 may be the same as, or different than, the drone hatch 170 previous described herein. Alternatively, the order depositing portion 500 may be open on the backside of the pick-up station 100. The order holding portion 510 (e.g., one or more containers 155 described herein, or the like) may be configured to hold the order until the user and/or autonomous delivery vehicle is identified as present. The order holding portion 510 may be adjustable vertically and/or horizontally to aid in receiving the order from the depositor (e.g., user or autonomous delivery system). Moreover, as described herein, the order holding portion 510 may be temperature controlled (e.g., heated, cooled, room-temp, ambient-temp, and/or the like) depending on the type of order. The order retrieval portion 520 may be configured to provide an order to the user once the user is identified as being located adjacent the object pick-up station 100, as previously described herein. The order retrieval portion 520, like the order depositing portion 500, may include a barrier (e.g., locker compartment barrier 140) that opens when the user is identified as being at the object pick-up station 100. In some embodiments, the order retrieval portion 520 may extend the object retrieval tray 160 containing the object(s) and/or extend the object(s) itself to the vehicle (e.g., to a user in the vehicle, to a compartment within an autonomous delivery vehicle, or the like). It should be understood that each object pick-up station 100 may include one or more order depositing portions 500 (e.g., a single barrier or multiple barriers for depositing an order), one or more order holding portions 510 (e.g., a single compartment 155 or multiple compartments 155), and/or one or more order retrieval portions 520 (e.g., a single barrier or multiple barriers for allowing a user to access an order). As such, an object pick-up station 100 may include a single locker with a single or multiple object retrieval compartments 155 (e.g., a single locker section, kiosk section, or the like) and/or multiple lockers with single or multiple object retrieval compartments 155 (e.g., multiple locker sections, kiosk sections, or the like stacked on top of and/or next to each other to form a bank of compartments).

Consequently, it should be understood, and as previously described herein, the object pick-up stations 100 may be stand-alone stations in which a single order may be delivered or a bank of stations in which multiple orders may be provided until the recipient pick-ups the object(s).

It should be understood that the object pick-up stations 100 may have components that are the same as or similar to the other systems described herein. For example, one or more processing devices, one or more network communication interfaces, one or more memory devices, or the like that allow the object pick-up stations 100 to communicate with the other systems and applications described herein.

The present invention allows for improved depositing and retrieval of objects from one or more pick-up stations 100. The lockers 110 of the pick-up stations 100 can be adjusted by the one or more adjustment assemblies 120 and/or have extendable trays to allow depositors and/or recipients to easily deposit and retrieve the objects from the lockers 100 without exiting a vehicle. Moreover, the adjustable pick-up stations 100 improve the efficiency of providing multi-vendor orders for multiple customers in a single location since portions of orders for multiple customers from multiple vendors may be delivered to pick-up stations 100 and consolidated into single deliveries for each of the customers. The adjustability of the pick-up stations 100 further improves the efficiency by allowing depositors and recipients to remain in vehicles when depositing and retrieving the consolidated orders.

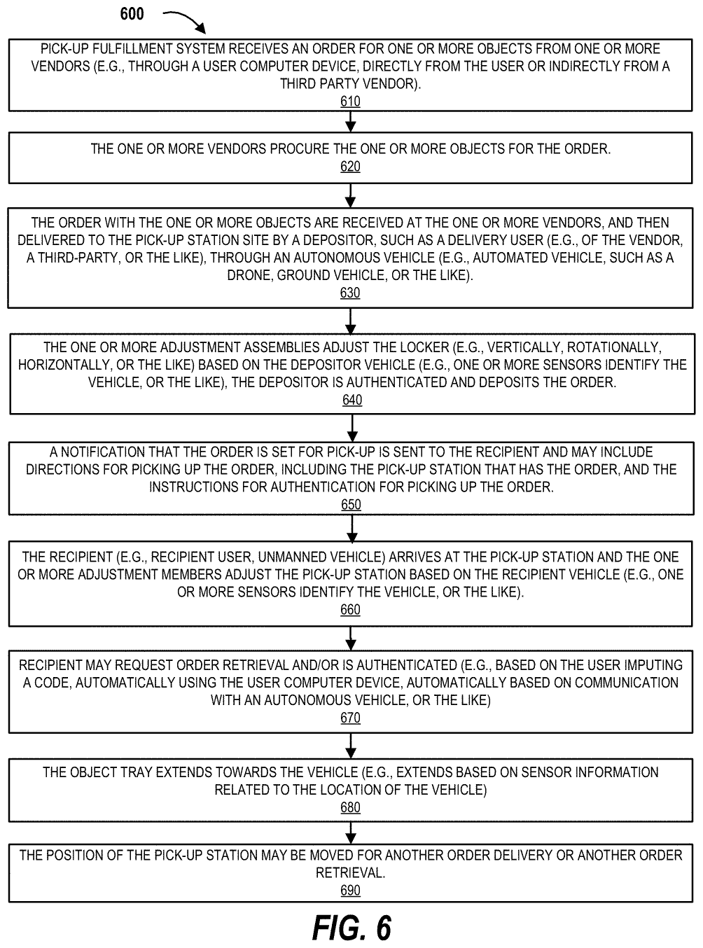

FIG. 6 illustrates a process flow 600 for order placement, depositing the order in the pick-up station 100, and retrieval of the order from the pick-up station 100, in accordance with some embodiments of the present disclosure. As illustrated in block 610, the pick-up fulfillment system 400 receives an order from a user (e.g., through a user computer system) for one or more objects from one or more vendors. The order may occur directly from a customer user or may be from a third-party user on behalf of the user. The order may include information related to the recipient that will be picking up the order, including vehicle information (e.g., type of vehicle, or the like) for the recipient picking up the order. In some embodiments, the vehicle information may be determined at a later time when the recipient arrives on site or is located adjacent to the pick-up station 100.

Block 620 of FIG. 6 further illustrates that the order is procured by the one or more vendors. For example, should the order be from a single vendor, the vendor may complete the order and prepare it for delivery to the pick-up station 100. In other examples, when the order includes objects from multiple vendors, the multiple vendors procure each portion of the order.

FIG. 6 illustrates in block 630 that when the orders are ready, one of the vendors or a third-party depositor may consolidate the order by picking up the objects for the order from multiple vendors. In some embodiments, each vendor or a third-party may act as a depositor for its portion of an order. In other embodiments, the depositor may pick up portions of multiple orders from one or more vendors (e.g., multiple orders of different customer users from one or more vendors), which will be delivered to the pick-up site for depositing to multiple pickup-stations 100, lockers 110 within a pick-up station, and/or compartments 155 within a pick-up station 100. For example, a single depositor may pick up two partial orders and a single complete order from a single vendor, before delivering the two partial orders and the single complete order to the pick-up station site.

Block 640 of FIG. 6 further illustrates that the order with one or more objects is delivered to the pick-up station site. In some embodiments, the depositor is a delivery user (e.g., of the vendor, third-party, or the like). In other embodiments, the depositor is an autonomous vehicle (e.g., ground vehicle, drone, or the like). As previously described herein, the one or more lockers 110 may be adjusted based on the depositor vehicle making the deposits of the order(s). The one or more adjustment assemblies 120 may adjust the height of one or more lockers 110 of one or more pick-up stations 100 based on the depositor vehicle making the delivery. Returning to the previous example, the depositor may deliver a complete order to a first container 155 within a first locker 110 of a first pick-up station 100, and one of the partial orders to a second container 155 within the first locker 110 (or a second locker 110) of the first pick-up station 100. Moreover, the depositor may deliver the second partial order to a container 155 within a locker 110 of a second pick-up station 100.

As illustrated in block 650, once an order for a recipient (e.g., third party delivery user, customer user, or the like) is deposited in the pick-up station 100, the pick-up fulfillment system 400 may send a notification to the recipient (e.g., on a computing device system 310, or the like) that the order is ready for pick-up. The notification may include pick-up instructions, such as authentication instructions, the pick-up station 100 and/or the locker 110 in which the order is located, or other information.

FIG. 6 further illustrates in block 660 that the recipient arrives at the pick-up site to pick-up the order. After the recipient arrives, the one or more adjustments assemblies 120 adjust the pick-up station (e.g., height of the locker 110, or the like) based on the vehicle information of the recipient (e.g., based on sensor readings, based on stored vehicle information for the recipient, or the like). Block 470 illustrates that the recipient is authenticated for access to the locker 110 (e.g., after inputting a code, allowing communication between the user computer device 310 and pick-up station 100, allowing communication between the autonomous vehicle and the pick-up station 100, or the like). The authentication may include any type of authentication process, such as using codes (e.g., alphanumeric codes, QR codes, barcodes, wireless communication between devices, two-factor authentication, biometric authentication, facial recognition, or any other type of authentication). It should be understood that the one or more adjustment assemblies 120 may be used to adjust the locker 110 of the pick-up station 100 before or after the recipient is authenticated.

Once the recipient has been authenticated for access to the order, the locker compartment barrier 140 is opened for access to the order. In some embodiments, an object tray (e.g., object retrieval tray) is extended towards the vehicle based on sensor information from one or more sensors. As described herein, the object tray may be extended (e.g., using tray drives and tray members) a distance such that the tray is located adjacent an opening in a vehicle (e.g., window opening, or the like) without damaging a vehicle.

Block 690 of FIG. 9 further illustrates that the position of the locker 110 of the pick-up station 100 may be moved for another order delivery by a depositor or another order retrieval by a recipient.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random-access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general-purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An object pick-up station for retrieving objects, the object pick-up station comprises:
a locker comprising:
an object compartment, wherein the object compartment is configured to store one or more objects for retrieval by a recipient;
an interface configured to authenticate the recipient; and
a locker barrier configured to allow access to the object compartment upon authentication of the recipient; and
one or more adjustment assemblies configured to adjust a position of the locker based on a recipient vehicle.

2. The object pick-up station of claim 1, further comprising:
one or more sensors configured to determine vehicle information of the recipient vehicle.

3. The object pick-up station of claim 1, further comprising:
an object tray configured to extend from the object compartment in a direction of the recipient vehicle adjacent to the object pick-up station, wherein the one or more objects are extended toward the recipient vehicle by the object tray.

4. The object pick-up station of claim 3, wherein the object tray comprises a retractable tray wall configured to raise and lower.

5. The object pick-up station of claim 1, wherein the interface is at least one of a scanner, a keypad, a touchscreen display, or a wireless communication device.

6. The object pick-up station of claim 1, wherein the one or more adjustment assemblies comprise:
an adjustment member; and
an adjustment drive.

7. The object pick-up station of claim 6, wherein the adjustment member comprises a telescoping leg, a rotational screw, a pivoting arm, or a carriage and track.

8. The object pick-up station of claim 6, wherein the adjustment drive comprises an electric motor, a hydraulic drive, a pneumatic drive, or an inflatable vessel.

9. The object pick-up station of claim 1, wherein the one or more adjustment assemblies adjust the position of the locker vertically.

10. The object pick-up station of claim 1, wherein the one or more adjustment assemblies adjust the position of the locker rotationally.

11. The object pick-up station of claim 1, wherein the one or more adjustment assemblies adjust the position of the locker horizontally.

12. The object pick-up station of claim 1, wherein the locker comprises two or more object compartments configured to store the one or more objects.

13. The object pick-up station of claim 1, wherein the locker further comprises a compartment drive configured to move the two or more object compartments within the locker.

14. The object pick-up station of claim 1, wherein the locker is temperature controlled.

15. The object pick-up station of claim 1, further comprising:
two or more lockers configured to store two or more orders.

16. The object pick-up station of claim 1, further comprising a trash disposal device configured to receive an object of the one or more objects from the object compartment.

17. A system for facilitating an object retrieval, the system comprises:
one or more network communication interfaces;
one or more memories having computer readable code stored therein; and
one or more processing devices operatively coupled to the one or more memories and the one or more network communication interfaces, wherein when executed the computer readable code causes the one or more processing devices to:
receive vehicle information of a vehicle;
activate one or more adjustment assemblies to adjust a locker position based on the vehicle information of the vehicle;
receive an object deposit request or an object retrieval request, wherein the object deposit request or the object retrieval request comprises authentication information for a user; and
based on the authentication information unlock a locker barrier, wherein the locker barrier is configured to allow access to an object compartment for one or more objects.

18. The system of claim 17, wherein when executed the computer readable code further causes the one or more processing devices to:
activate an object tray configured to extend from the object compartment in a direction of the vehicle adjacent to the object pick-up station, wherein the one or more objects are extended toward the vehicle by the object tray.

19. A method for facilitating an object retrieval from an object pick-up station comprising a locker comprising an object compartment, an interface configured to authenticate a depositor or a recipient, and a locker compartment barrier, and one or more adjustment assemblies configured to adjust a position of the locker, the method comprises:
receiving vehicle information of a vehicle;
activating the one or more adjustment assemblies to adjust the position of the locker based on the vehicle information of the vehicle;
receiving an object deposit request or an object retrieval request, wherein the object deposit request or the object retrieval request comprises authentication information for the depositor or the recipient; and
based on the authentication information unlock a locker barrier, wherein the locker barrier is configured to allow access to the object compartment for depositing or retrieval of one or more objects.

20. The method of claim 19, further comprising
activating an object tray configured to extend from the object compartment in a direction of the vehicle adjacent to the object pick-up station.
